(19) United States
(12) Patent Application Publication
(10) Pub. No.: US 2007/0289468 A1
(43) Pub. Date: Dec. 20, 2007

(54) On-press imaging lithographic printing press and method

(76) Inventor: Gary Ganghui Teng, Northborough, MA (US)

Correspondence Address: Gary Ganghui Teng, 10 Kendall Dr., Northborough, MA, 01532, US

(21) Appl. No.: 11/453,522

(22) Filed: Jun. 14, 2006

(51) Int. Cl. B41N 3/00

(52) U.S. Cl. 101/467

(57) ABSTRACT

A lithographic printing press having a plate cylinder in a light-tight compartment suitable for on-press imaging and developing a violet or ultraviolet laser sensitive plate is described. The plate cylinder as well as certain other press parts is covered by non-transparent or safe-light-only covers so that no or substantially no light or unsafe light passes onto the plate mounted on the plate cylinder during on-press imaging and development. The plate comprises on a substrate a photosensitive layer soluble or dispersible in ink and/or fountain solution and capable of hardening upon exposure to a violet or ultraviolet laser. The plate is on-press exposed with the laser, developed with ink and/or fountain solution, and then directly prints images to the receiving sheets.

### FIELD OF THE INVENTION

This invention relates to lithographic printing. More particularly, it relates to lithographic printing press suitable for on-press imaging and developing a violet or ultraviolet laser sensitive lithographic printing plate and method of using such press and plate.

### BACKGROUND OF THE INVENTION

Lithographic printing is generally performed on a lithographic printing press using a lithographic printing plate (also called planographic printing plate). Lithographic printing plate (after process) generally consists of ink-receptive areas (image areas) and ink-repelling areas (non-image areas); the image areas and the non-image areas are substantially on the same plane. During printing operation, ink is preferentially received in the image areas, not in the non-image areas, and then transferred, usually through a printing blanket, to the surface of a material upon which the image is to be produced.

Lithographic printing plates (processed) are generally prepared from lithographic printing plate precursors (also commonly called lithographic printing plates) comprising a substrate and a photosensitive coating deposited on the substrate, the substrate and the photosensitive coating having opposite surface properties. The photosensitive coating is usually a photosensitive material, which solubilizes or hardens upon exposure to an actinic radiation, optionally with further post-exposure overall treatment. In positive-working systems, the exposed areas become more soluble and can be developed to reveal the underneath substrate. In negative-working systems, the exposed areas become hardened and the non-exposed areas can be developed to reveal the underneath substrate. In addition to conventional ultraviolet lamp which exposes a lithographic plate through a separate photomask, laser sources have been increasingly used to directly imagewise expose a lithographic plate that is sensitized to a corresponding laser.

The exposed plate is usually developed with a liquid developer to bare the substrate in the non-hardened or solubilized areas. On-press developable lithographic printing plates have been disclosed in the literature. Such plates can be directly mounted on press after exposure to develop with ink and/or fountain solution during the initial prints and then to print out regular printed sheets. No separate development process before mounting on press is needed. Among the patents describing on-press developable lithographic printing plates are U.S. Pat. Nos. 5,258,263, 5,516,620, 5,561,029, 5,616,449, 5,677,110, 5,811,220, 6,014,929, 6,071,675, 6,482,571, 6,737,220, 6,994,028, 6,969,575, and 6,949,327. Some of the most recent patents also propose on-press laser exposure and development of an on-press developable plate.

Lithographic printing presses installed with a laser exposure device have recently been proposed in the patent literature. Examples include U.S. Pat. Nos. 6,543,348, 6,737,220, and 6,539,859, and U.S. Pat. App. Pub. No. 2003/0081106. Infrared laser is generally used to expose the plate mounted on press according to digital imaging information. Like conventional presses, these presses with laser imager are not designed to be light-tight so that the plate mounted on the plate cylinder sees the room light, directly or indirectly. Such presses are suitable for on-press imaging and developing infrared laser sensitive plate that has low or no sensitivity to the office white light. However, such presses, even if installed with a violet or ultraviolet laser, are not suitable for on-press imaging and developing a violet or ultraviolet plate under regular room light because of the very high white light sensitivity of such plate.

The exposure device for violet or ultraviolet laser sensitive plate can be built at lower cost and is more reliable than an infrared laser exposure device because of the lower cost and better reliability of violet or ultraviolet laser diode. On-press imaging and developing of a violet or ultraviolet laser sensitive plate would allow significant saving on the equipment and maintenance cost, and eliminate the hazardous liquid waste as associated with conventional plate. It would be desirable if an on-press imaging press and method can be developed which allow the use of violet or ultraviolet laser sensitive on-press developable plate under regular office light.

### SUMMARY OF THE INVENTION

According to the present invention, there has been provided a lithographic printing press, comprising:
(a) a plate cylinder;
(b) an exposure means capable of emitting a laser with a wavelength selected from 250 to 430 nm to imagewise expose a lithographic printing plate mounted on said cylinder; and
(c) an inking means comprising an inking unit or both an inking unit and a fountain unit;
(d) wherein at least said plate cylinder as well as the plate mounted on it is within a compartment shielded with covers and other press parts so that no or less than 5% of the room light with wavelength of less than 450 nm reaches the plate mounted on the plate cylinder.

The above plate cylinder is preferably mounted with a lithographic printing plate comprising on a substrate a photosensitive layer soluble or dispersible in ink and/or fountain solution and capable of hardening upon exposure to said laser at a dosage of less than 500 μJ/cm² (microjoule/cm²) at the beginning of a printing operation.

According to another aspect of the present invention, there has been provided a method of lithographically printing images on a receiving medium, comprising in order:
(a) providing a lithographic printing press comprising (i) a plate cylinder (ii) an exposure means capable of emitting a laser having a wavelength selected from 250 to 430 nm, and (iii) an inking means comprising an inking unit or both an inking unit and a fountain unit;
(b) mounting onto said plate cylinder a lithographic printing plate comprising on a substrate a photosensitive layer soluble or dispersible in ink and/or fountain solution and capable or hardening upon exposure to said laser,
(c) imagewise exposing said plate with said laser at a dosage of less than 500 μJ/cm² to cause hardening of the photosensitive layer in the exposed areas; and
(d) applying ink and/or fountain solution from said inking means to said plate to remove the non-hardened areas of said photosensitive layer and to print images from said plate to the receiving medium;
(e) wherein at least said plate mounted on the plate cylinder is within a compartment shielded with covers and other press parts so that no or less than 5% of the room light with wavelength shorter than 450 nm reaches the plate.

The term “the room light with wavelength shorter than 450 nm” means the below-450 nm portion of the room light. The term “less than 5% of the room light with a wavelength shorter than 450 nm reaches the plate” means the intensity for light coming from outside of the press at each wavelength below 450 nm around the plate cylinder is less than 5% of the intensity of the light at such wavelength around outer top surface of the press under normal office lighting (with light coming from the ceiling lamps). The compartment can be in the dark or substantially dark, or have yellow or red light coming through the yellow or red transparent covers from the room light. Preferably less than 1%, more preferably less than 0.2% and most preferably none, of the room light or of the portion of the room light with wavelengths below 450 nm reaches the plate cylinder.

The covers together with other press parts prevent all or at least 95% of the room light or of the portion of the room light having wavelengths below 450 nm from reaching the plate mounted on the plate cylinder to cause undesired photo reaction of the photosensitive layer of the plate. The covers and other press parts can be non-transparent to light or only transparent to light with wavelength above 450 nm, preferably above 500 nm, most preferably above 550 nm. Preferably, the covers have some areas non-transparent to any room light and some other areas only transparent to yellow or red light. The compartment can cover (i) the plate cylinder, part of the exposure means, and part of the inking means; (ii) the plate cylinder, the exposure means, and part of the inking means; (iii) the plate cylinder, the exposure means, and the inking means; (iv) the plate cylinder, the blanket cylinder, the impression cylinder, the exposure means, the inking means, the medium to be fed, and the printed medium; or (v) the entire press except for certain controlling handles or buttons; as long as the plate mounted on the plate cylinder is shielded from at least 95% of the room light having wavelength of less than 450 nm and all the press moving parts can move as designed. Preferably, the compartment covers the entire press except for certain control buttons. The compartment can be connected to a light-tight cassette containing the plate to be fed or has a light-tight slot for feeding a plate from a light-tight cassette or bag or covered with a non-transparent cover sheet, or the plate can be automatically mounted on the surface of the plate cylinder from a roll of fresh plate in a light-tight cartridge stored inside the plate cylinder.

### BRIEF DESCRIPTION OF THE DRAWINGS

FIG. 1 is a diagranunatic cross-sectional view of a lithographic printing press of the invention having a fully covered conipartrnent for the plate cylinder and other parts, which compartment is fully or sabstantially fully blocked from the room light or the unsafe portion of the room light.

FIG. 2 is a diagrammatic cross-sectional view of a lithographic printing press of the invention wherein The light-tight compartment has a light-tight slot on the cover to allow the entrance of the plate without letting light enter the compartment.

FIG. 3 is a diagranunatic cross-sectional view of a lithographic printing press of the invention wherein the light-tight compartment covers only part of the press components including the plate cylinder, the exposure means, part of the inking system, and part of the blanket cylinder to ensure that the plate mounted on the plate cylinder is blocked from at least 90% of the room light or of the unsafe portion of the room light.

FIG. 4 is a diagrammatic cross-sectional view of a lithographic printing press of the invention wherein the plate is installed inside the cylinder in The form of roll.

FIG. 5 is a diagranunatic cross-sectional view of a multicolor lithographic printing press of the invention with 4 sets of plate cylinders and blanket cylinders sharing the same impression cylinder.

FIG. 6 is a diagrammatic cross-sectional view of a multicolor lithographic printing press of the invention with 4 single-color printing units lined up in tandem.

FIG. 7 is a diagrammatic cross-sectional view of a multicolor lithographic printing press of the invention with 4 single-color printing units lined up in tandem wherein the medium to be printed is a web instead of sheet.

### DETAILED DESCRIPTION OF THE PREFERRED EMBODIMENTS

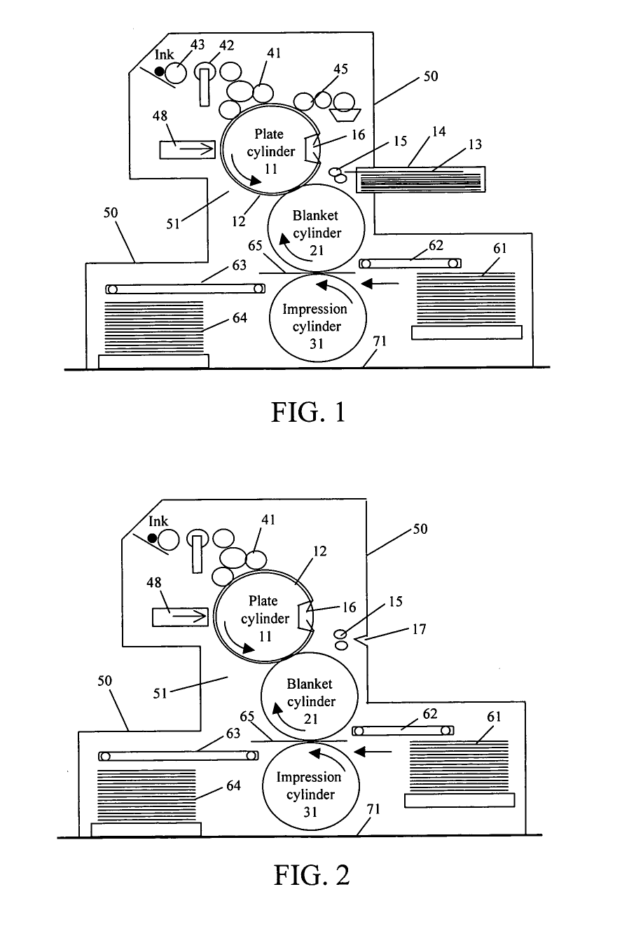

Any lithographic printing presses having at least one plate cylinder, including all current commercial lithographic presses and the lithographic presses described in the patent literature, can be modified into the printing press of the current invention by adding covers to block off all or at least 95% (preferably at least 99%, more preferably at least 99.8%, and most preferably all) of the room light or of the unsafe portion of the room light (with wavelength below 450 nm) from reaching the plate cylinder and by adding an exposure means having a violet or ultraviolet laser (having a wavelength selected from 250 to 430 nm). Preferably, at least 95% (preferably at least 99%, more preferably at least 99.8%, and most preferably all) of the unsafe portion of the room light is prevented from reaching the plate. The lithographic press of the instant invention can be designed in various ways, using any of the current lithographic press designs and any design and arrangement of covers to block off all or at least 95% of the unsafe light from entering the compartment containing the plate cylinder without hindering the designed motions or rotations of the moving parts of the press. Portion of the covers can be opened after on-press imaging and development to allow easy viewing or adjustment inside the press, such as adjusting the ink or fountain unit, adjusting the plate, or handling the paper. Some of the preferred designs of the lithographic press of the instant invention are illustrated in FIGS. 1-7. However, various modifications can be made to achieve the current invention, as long as the lithographic press having a violet or ultraviolet laser exposure means is shielded with covers which prevent all or at least 95% (preferably at least 99%, more preferably at least 99.8%, and most preferably all) of the room light or of the unsafe portion of the room light from reaching the plate cylinder.

Although it is ideal to block off all the room light or unsafe portion of the room light from entering the compartment containing the plate cylinder, small amount of undesired light may leak in, for example, from certain small gaps between various parts and covers, due to the slight transparency to unsafe light of certain cover materials, or due to design limitations. Such small amount of light (less than 5%, preferably less than 1% and more preferably less than 0.2% of the room light) is acceptable as long as it does not cause undesirable photo reaction to effect the performance of the particular plate.

As illustrated in FIG. 1, the lithographic printing press of this invention has a fully covered compartment for the plate cylinder and other parts, which compartment is fully or substantially fully blocked from the room light or the unsafe portion of the room light. The printing press comprises a plate cylinder 11 for mounting a printing plate 12, an inking unit 41 for applying ink to the plate 12, a fountain unit 45 for applying fountain solution to the plate 12, a violet or ultraviolet laser exposure means 48 for exposing the plate 12 with a violet or ultraviolet laser according to digital imaging information, a blanket cylinder 21 for receiving the inked imaging from the plate 12 to transfer to the receiving medium 65, an impression cylinder 31 for pressing the receiving medium 65 against the blanket cylinder 21, and a light-tight cassette 14 for supplying and feeding the plate 13 to the plate cylinder 11 without exposing the plate to any light or any unsafe light. The medium to be printed 61 is fed to between the blanket cylinder 21 and the impression cylinder 31 through a feeding means 62, and then transported to the printed medium pile 64 through a transporting means 63. A loading unit 15 picks up the plate from the cassette and transports to the plate cylinder 11. The plate cylinder has an automatic mounting unit 16 that automatically mounts the plate 12 onto the plate cylinder 11. The plate cylinder and other press parts are covered with the covers 50 that block off all or at least 95% of the room light or of the unsafe portion of the room light. The bottom 71 can be the floor of the room or can be part of the press. The duct roller 43 and vibrator 42 transfer ink to the ink rollers and are part of the inking unit. After the plate 12 is imaged and on-press developed, part of the covers can be opened to allow easy viewing or adjustment or better ventilation. The components of the press are generally mounted on an upstanding machine frame (not shown), and all moving parts are capable of moving or rotating as designed. It is noted that the inking unit 41, and fountain unit 45 (if any), are together called inking system or inking means in this application.

In addition to loading the plate from the cassette, the plate can be mounted onto the plate cylinder of the press of FIG. 1 by any means. For example, the plate can be manually mounted on press with a portion of the covers 50 in the open position while under yellow or red room light, and the opened portion of the covers 50 can then be closed and the room light is switched to white light to start laser imaging and on-press development. Also, the plate can be covered with a non-transparent cover sheet, and mounted on the plate cylinder with a portion of the covers 50 in an open position under white room light; the covers can then be fully covered; a peeling device installed near the plate cylinder can be activated to peel off the cover sheet; and the plate is then imaged and on-press developed. Once the plate is on-press developed, some of the covers can be in the open position.

FIG. 2 illustrates a printing press of the instant invention wherein the light-tight compartment 51 has a light-tight slot 17 on the cover to allow the entrance of the plate without letting light entering the compartment 51. The plate can be fed from a light-tight cassette, light-tight bag, or covered with a non-transparent cover sheet. The cassette, bag, or cover sheet can be left outside or inside of the light-tight slot. A peeling device can be installed around the slot to peel off the cover sheet without exposing the photosensitive layer of the plate to the room light. The press as illustrated has an inking unit 41, but does not have fountain unit. Such press is suitable for printing waterless plate that requires ink only or for printing wet plate using single fluid ink. However, this press can be further installed with a fountain unit to print wet plate with regular ink. The plate cylinder and other press parts are covered with the covers 50 which block off all or at least 95% of all room light or unsafe portion of the room light.

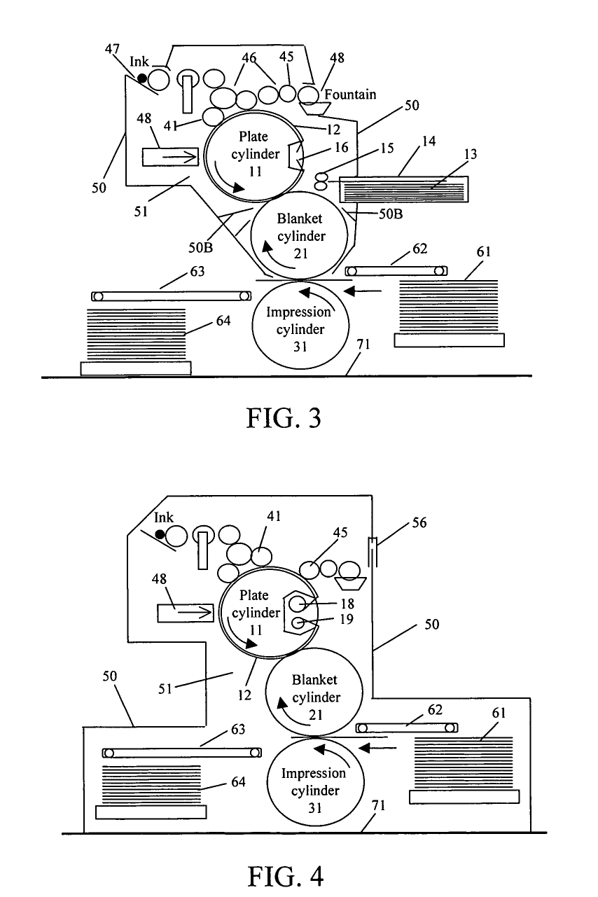

FIG. 3 illustrates a printing press of the instant invention wherein the light-tight compartment 51 covers only part of the press components including the plate cylinder 11, the exposure means 48, part of the inking system 46, and part of the blanket cylinder 21 to ensure that the plate 12 mounted on the plate cylinder 11 is blocked from at least 95% of the room light or of the unsafe portion of the room light. Both the ink reservoir 47 and the fountain reservoir 48 are outside of the compartment to allow ease of adding ink and fountain solution. Several layers of covers 50B are installed closely around the blanket cylinder 21 preferably without touching it to block off most of the room light from entering the compartment. This press employs an integrated inking system 46 wherein the fountain is transferred through fountain rollers 45 to the inking rollers 41 to form emulsion of ink and fountain before applying to the plate 12 mounted on the plate cylinder 11. This integrated inking system is an alternative to a conventional inking system as in FIG. 1 wherein the fountain and ink are separately applied to the plate mounted on the plate cylinder. Both conventional and integrated inking systems are well known and either can be used on a wet press of the instant invention.

FIG. 4 illustrates a printing press of the instant invention wherein the plate is installed inside the cylinder in the form of roll. The plate 12 is pulled out from the original unexposed plate roll 18 to mount onto the plate cylinder 11 and then wound onto the used plate roll 19. The plate in roll 18 is preferably in a light-tight cartridge so that it is not exposed to light even under room light. After the completion of a printing job and before a new printing job, preferably automatically, the printed portion of the plate mounted on the plate cylinder can be wound onto the used plate roll 19 and a fresh portion of the plate can be pulled out from the fresh plate roll 18 to mount on the plate cylinder to start a new laser exposure, on-press development, and printing cycle. A labyrinth 56 that passes air without passing significant amount of light is optionally contained on the covers 50 to allow ventilation.

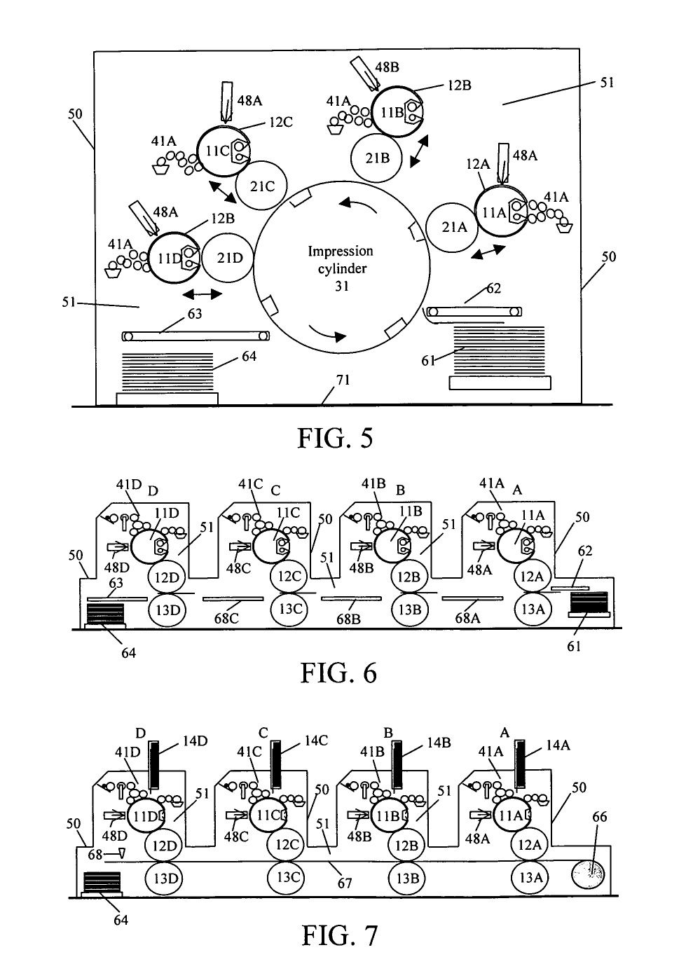

FIG. 5 illustrates a multicolor press with 4 sets of plate cylinders 11A-D and blanket cylinders 21A-D sharing the same impression cylinder 31. The plates in the form of roll are installed inside the cylinders and automatically pulled out from the rolls to mount on the plate cylinders for each new printing job. All the plate cylinders and other press parts are covered with the covers 50 that block off all or at least 95% of all light or unsafe light.

FIG. 6 illustrates a multicolor press with 4 single-color printing units A-D lined up in tandem. The medium to be printed 61 is printed first on printing unit A with the first color, further passes through printing unit B to be printed for the second color, further passes through printing unit C to be printed for the third color, further passes through printing unit D to be printed for the fourth color, and then collected onto the pile of printed medium 64. All the plate cylinders and other press parts are covered with the covers 50 which block off all or at least 95% of the room light or the unsafe portion of the room light.

FIG. 7 illustrates a multicolor press with 4 single-color printing units A-D lined up in tandem. The medium to be printed is a web instead of sheet. It is unwound from the roll of fresh medium (typically paper) 66, passes through the 4 printing units to be printed with 4 different colors, cut into sheets with cutter 68, and then collected onto the pile of printed medium 64. All the plate cylinders and other press parts are covered with the covers 50 which block off all or at least 95% of the room light or the unsafe portion of the room light.

The covers can be all non-transparent to all room light, all transparent to safe light only, or non-transparent to any room light in certain parts and transparent to safe light only in other parts. Preferably, the covers are non-transparent in certain parts and only transparent to safe light in other parts. The lithographic press of this invention preferably has a portion of the covers being only transparent to light of above 450 nm, more preferably above 500 nm, and most preferably above 550 nm, with the rest of the covers being non-transparent. Such a press allows viewing of the plate cylinder and other internal parts through a yellow or red window (as part of the covers). Some of the covers for the press can be opened after the plate has been on-press imaged and developed, to allow ease of viewing, adjustment and ventilation. An interlocking mechanism can be designed so that all the covers are closed during plate mounting, imaging and on-press development.

A small pipe can be connected between the inside and outside of the compartment to allow ventilation. The pipe can be curved many times and preferably have dark internal surface so that no or substantially no light passes into the compartment through the pipe. Small opening on the covers with objects to block off the direct light, preferably in areas of the covers far from the plate cylinder, can be made to allow ventilation. Such opening is also called labyrinth, which allows air to pass through without passing significant amount of light. In any event, only less than 5% (preferably less than 1%, more preferably less than 0.2%, and most preferably none) of the room light or unsafe portion of the room light can reach the plate cylinder.

A safe light, such as a red or yellow light, can be installed inside the compartment to facilitate viewing inside the compartment during plate mounting, imaging, and on-press development. Of course, white light can also be installed inside the compartment, but can not be turned on until the plate has been imaged and on-press developed.

The lithographic plate can be supplied as sheet or roll in a light-tight state, such as in a cartridge or cassette or covered with a non-transparent cover sheet, and is preferably automatically loaded onto the plate cylinder. The light-tight cartridge or cassette is non-transparent to any room light or only transparent to safe light (with wavelengths above 450 nm, preferably above 500 nm, and most preferably above 550 nm). Preferably, the light-tight cartridge or cassette is non-transparent to any room light.

In this patent, the term yellow or red light means a visible light having wavelengths above at least 450 nm, preferably above 500 nm, and more preferably above 550 nm; including any yellow light, red light, or any light with color between red and yellow, such as from an incandescence or fluorescence lamp with a yellow or red cap. The term safe light means a yellow or red light. The term unsafe light or unsafe portion of the room light is defined as light with wavelength below 450 nm. The term room light includes any light in a typical office, such as white fluorescence light, white incandescence light, and sunlight (coming from the windows to the pressroom). The term light-tight means no light or no light with wavelengths below 450 nm can pass through; preferably no light can pass through.

The substrate employed in the lithographic plates of this invention can be any lithographic support. Such a substrate can be a metal sheet, a polymer film, or a coated paper. Aluminum (including aluminum alloy) sheet is a preferred metal support. Particularly preferred is an aluminum support that has been grained and anodized (with or without deposition of a barrier layer). Polyester film is a preferred polymeric film support. A surface coating may be coated to achieve desired surface properties. For wet plate, the substrate should have a hydrophilic or oleophilic surface, depending on the surface properties of the photosensitive layer; commonly, a wet lithographic plate has a hydrophilic substrate and an oleophilic photosensitive layer. For waterless plate, the substrate should have an oleophilic or oleophobic surface, depending on the surface properties of the photosensitive layer.

Particularly suitable hydrophilic substrate for a wet lithographic plate is an aluminum support that has been grained and anodized; such a substrate is preferably further deposited with a hydrophilic barrier layer. Surface graining (or roughening) can be achieved by mechanical graining or brushing, chemical etching, and/or AC electrochemical graining. The roughened surface can be further anodized to form a durable aluminum oxide surface using an acid electrolyte such as sulfuric acid and/or phosphoric acid. The roughened and anodized aluminum surface can be further thermally or electrochemically coated with a layer of silicate or hydrophilic polymer such as polyvinyl phosphonic acid, polyacrylamide, polyacrylic acid, polybasic organic acid, copolymers of vinyl phosphonic acid and acrylamide to form a durable hydrophilic layer. Polyvinyl phosphonic acid and its copolymers are preferred polymers. Processes for coating a hydrophilic barrier layer on aluminum in lithographic plate application are well known in the art, and examples can be found in U.S. Pat. Nos. 2,714,066, 4,153,461, 4,399,021, and 5,368,974. Suitable polymer film supports for a wet lithographic plate include a polymer film coated with a hydrophilic layer, preferably a hydrophilic layer that is crosslinked, as described in U.S. Pat. No. 5,922,502.

For preparing lithographic printing plates of the current invention, any photosensitive layer is suitable which is capable of hardening upon exposure to a laser having a wavelength selected from 250 to 430 nm, and is soluble or dispersible in ink (for waterless plate) or in ink and/or fountain solution (for wet plate). Here hardening means becoming insoluble and non-dispersible in ink and/or fountain solution. Hardening is generally achieved through crosslinking or polymerization of the resins (polymers or monomers). The photosensitive layer preferably has a coverage of from 100 to 4000 mg/m², and more preferably from 400 to 2000 mg/m².

Preferably, the photosensitive layer comprises a polymerizable monomer and an initiating system, optionally with addition of a polymeric binder. The initiating system generally comprises an initiator; an initiator and a sensitizing dye; or an initiator, a sensitizing dye and a hydrogen donor; depending on the specific photosensitive layer. Either one species (such as 1 initiator or 1 polymer) or more than one species of the same component type (such as 2 different initiators or 3 different monomers) can be added in the same photosensitive layer. The composition ratios (such as monomer to polymer ratio) are usually different from conventional plates designed for development with a regular liquid developer. Various additives may be added to, for example, allow or enhance on-press developability. Such additives include surfactant, plasticizer, water soluble polymer or small molecule, and ink soluble polymer or small molecule. The addition of nonionic surfactant is especially helpful in making the photosensitive layer dispersible with ink and fountain solution, or emulsion of ink and fountain solution. Various additives useful for conventional photosensitive layer can also be used. These additives include pigment, dye, exposure indicator, and stabilizer.

In this patent, the term monomer includes both monomer and oligomer, and the term (meth)acrylate includes both acrylate and methacrylate (A monomer means a monomer or an oligomer, and a (meth)acrylate monomer means an acrylate monomer, a methacrylate monomer, or a monomer with both acrylate and methacrylate groups.). The term monomer to polymer weight ratio means the weight ratio of all the specific monomers to all the polymeric binders (which are solid film-forming polymers); liquid polymer such as nonionic surfactant is not considered polymeric binder and is not included in the monomer to polymer weight ratio calculation. The term “comprises a . . . ” means “comprises at least one . . . ”; for example, the term “comprising a monomer” means “comprising at least one monomer.”

Photosensitive materials useful as photosensitive layer of this invention include, for example, photosensitive compositions comprising a polymerizable monomer, an initiator, a violet or ultraviolet sensitizing dye, and optionally a polymeric binder. A hydrogen donor is preferably added to accelerate the polymerization.

Photosensitive materials useful in wet plates of this invention include, for example, photosensitive compositions comprising an oleophilic polymeric binder, a polymerizable monomer, an initiator, and optionally a sensitizing dye.

Photosensitive oleophobic materials useful in waterless plates of this invention include, for example, compositions comprising a monomer having perfluoroalkyl or polysiloxane groups and crosslinkable terminal groups, an initiator, and optionally a sensitizing dye.

Polymeric binder useful for the photosensitive layer of this invention can be any solid film-forming polymer. The polymer may or may not have (meth)acrylate groups or other ethylenic groups (such as allyl groups). Examples of suitable polymers include (meth)acrylic polymers and copolymers (such as polybutylmethacrylate, polyethylmethacrylate, polymethylmethacrylate, polymethylacrylate, butylmethacrylate/methylmethacrylate copolymer, methylmethacrylate/methylmethacrylic acid copolymer, polyallylmethacrylate, and allylmethacrylate/methacrylic acid copolymer), polyvinyl acetate, polyvinyl butyrate, polyvinyl chloride, styrene/acrylonitrile copolymer, styrene/maleic anhydride copolymer and its partial ester, nitrocellulose, cellulose acetate butyrate, cellulose acetate propionate, vinyl chloride/vinyl acetate copolymer, butadiene/acrylonitrile copolymer, and polyurethane binder. The polymeric binder suitable for the photosensitive layer of this invention has a weight average molecular weight of at least 5,000, preferably from 10,000 to 1,000,000, more preferably from 20,000 to 500,000, and most preferably from 50,000 to 200,000 Dalton.

Suitable free-radical polymerizable monomers include any monomer or oligomer with at least one ethylenically unsaturated group. Such monomers include monofuctional, difunctional, and multifunctional (meth)acrylate monomers or oligomers, such as (meth)acrylate esters of ethylene glycol, trimethylolpropane, pentaerythritol, ethoxylated ethylene glycol and ethoxylated trimethylolpropane; multifunctional urethanated (meth)acrylate; epoxylated (meth)acrylate; and oligomeric amine (meth)acrylates. The monomers can be urethane (meth)acrylate, or non-urethane (meth)acrylate. Here a urethane (meth)acrylate monomer means any compound having at least one urethane linkage (—NHCOO—) and at least one (meth)acrylate group, and a non-urethane (meth)acrylate monomer means any (meth)acrylate monomer without urethane linkage (—NHCOO—) in the molecule. Combination of both urethane (meth)acrylate and non-urethane (meth)acrylate monomers can be used. The monomers preferably has at least 3 (meth)acrylate groups, more preferably at least 4 (meth)acrylate groups, even more preferably at least 5 (meth)acrylate groups, and most preferably at least 6 (meth)acrylate groups. However, monofuctional or difunctional (meth)acrylate monomer can be added into the photosensitive layer having multifunctional (meth)acrylate monomers; the total amount of such monofuctional or difunctional monomers is preferably less than 50% by weight of the total monomers, more preferably less than 30%, and most preferably less than 10%. Acrylate monomer is preferred over methacrylate monomer because of the faster photospeed of acrylate group over methacrylate group. The monomer has a molecular weight of less than 5,000, preferably from 100 to 3,000, more preferably from 200 to 2,000, and most preferably from 300 to 1,500 Dalton.

The initiators useful for the photosensitive layer of this invention include any initiators capable of generating free radicals or other activating species to cause polymerization of the monomers upon exposure to a violet or ultraviolet laser, with or without the presence of a sensitizing dye. Suitable free-radical initiators include, for example, onium salts such as diaryliodonium hexafluoroantimonate, diaryliodonium hexafluorophosphate, diaryliodonium triflate, (4-(2-hydroxytetradecyl-oxy)phenyl)phenyliodonium hexafluoroantimonate, (4-octoxyphenyl)phenyliodonium hexafluoroantimonate, bis(4-t-butylphenyl)iodonium hexafluorophosphate, triarylsulfonium hexafluorophosphate, triarylsulfonium p-toluenesulfonate, (3-phenylpropan-2-onyl)triaryl phosphonium hexafluoroantimonate and N-ethoxy(2-methyl)pyridinium hexafluorophosphate, and the onium salts as described in U.S. Pat. Nos. 5,955,238, 6,037,098 and 5,629,354; borate salts such as tetrabutylammonium triphenyl(n-butyl)borate, tetraethylammonium triphenyl(n-butyl)borate, diphenyliodonium tetraphenylborate, and triphenylsulfonium triphenyl(n-butyl)borate, and the borate salts as described in U.S. Pat. Nos. 6,232,038 and 6,218,076; haloalkyl substituted s-triazines such as 2,4-bis(trichloromethyl)-6-(p-methoxy-styryl)-s-triazine, 2,4-bis(trichloromethyl)-6-(4-methoxy-naphth-1-yl)-s-triazine, 2,4-bis(trichloromethyl)-6-piperonyl-s-triazine and 2,4-bis(trichloromethyl)-6-[(4-ethoxyethylenoxy)-phen-1-yl]-s-triazine, and the s-triazines as described in U.S. Pat. Nos. 5,955,238, 6,037,098, 6,010,824, and 5,629,354; hexaarylbiimidazole compounds such as 2,2′-bis(2-chlorophenyl)-4,4′,5,5′-tetraphenyl-1,1′-biimidazole, 2,2′-bis(2-ethoxyphenyl)-4,4′,5,5′-tetraphenyl-1,1′-biimidazole, and 2-(1-naphthyl)-4,5-diphenyl-1,2′-biimidazole; and titanocene compounds such as bis(η⁹-2,4-cyclopentadien-1-yl) bis[2,6-difluoro-3-(1H-pyrrol-1-yl)phenyl) titanium. The hexaarylbiimidazole compounds and titanocene compounds are preferred initiators, and hexaarylbiimidazole compounds are more preferred. One or more initiators can be added in a photosensitive layer. The initiator is added in the photosensitive layer preferably at 0.5 to 40% by weight of the photosensitive layer, more preferably at 2 to 30%, and most preferably at 5 to 20%.

Violet or ultraviolet laser sensitizing dyes useful in the photosensitive layer of this invention include any dyes capable of absorbing the violet or ultraviolet laser to activate the initiator to cause polymerization of the monomers. Suitable violet or ultraviolet laser sensitive dyes include, for example, cyanine dyes (including polymethine dyes); chromanone compounds such as 4-diethylaminobenzilidene chromanone; dialkylaminobenzene compounds such as ethyl 4-dimethylaminobenzoate and dialkylaminobenzene; dialkylaminobenzophenone compounds such as 4,4′-bis(dimethylamino)benzophenone, 4,4′-bis(diethylamino)benzophenone, 2-(p-dimethylaminophenyl)benzooxazole, 2-(p-diethylaminophenyl)benzooxazole, 2-(p-diethylaminophenyl)benzo[4,5]benzooxazole, 2-(p-dimethylaminophenyl)benzo[6,7]benzooxazole, 2,5-bis(p-diethylaminophenyl)1,3,4-oxazole, 2-(p-dimethylaminophenyl)benzothiazole, 2-(p-diethylaminophenyl)benzothiazole, 2-(p-dimethylaminophenyl)benzimidazole, 2,5-bis(p-diethylaminophenyl)1,3,4-thiadiazole, (p-dimethylaminophenyl(pyridine, (p-diethylaminophenyl)pyridine, 2-(p-dimethylaminophenyl)quinoline, 2-(p-dimethylaminophenyl)quinoline, 2-(p-diethylaminophenyl)pyrimidine or 2-(p-diethylaminophenyl)pyrimidine; unsaturated cyclopentanone compounds such as 2,5-bis{[4-(diethylamino)phenyl]methylene}-(2E,5E)-(9Cl)-cyclopentanone and bis(methylindolenyl)cyclopentanone; coumarin compounds such as 3-benzoyl-7-methoxy coumarin and 7-methoxy coumarin; and thioxanthene compounds such as 2-isopropylthioxanthenone. Dialkylaminobenzene compounds (including bis(dialkylamino)benzophenone compounds) are particularly suitable for ultraviolet laser sensitive plate. Bis(dialkylamino)benzophenone compounds are particularly suitable for violet laser sensitive plate. The sensitizing dyes as described in U.S. Pat. Nos. 5,422,204 and 6,689,537, and U.S. Pat. App. Pub. No. 2003/0186165 can be used for the photosensitive layer of this invention. The sensitizing dye is added in the photosensitive layer preferably at 0.1 to 20% by weight of the photosensitive layer, more preferably 0.5 to 15%, and most preferably 1 to 10%.

The free radical polymerizable photosensitive composition of the present invention preferably contains one or more hydrogen donors as polymerization accelerator. Examples of hydrogen donor include compounds having a mercapto group such as 2-mercaptobenzothiazole, 2-mercaptobenzimidazole, 2-mercaptobenzoxazole and 3-mercapto-1,2,4-triazole, N,N-dialkyl benzoic alkyl ester, N-aryl-α-amino acids, their salts and esters such as N-phenylglycine, salts of N-phenylglycine, and alkyl esters of N-phenylglycine such as N-phenylglycine ethyl ester and N-phenylglycine benzyl ester.

At least one surfactant is preferably added into the photosensitive layer to allow or enhance on-press developability with ink and/or fountain. Both polymeric and small molecule surfactants can be used. However, it is preferred that the surfactant has low or no volatility so that it will not evaporate from the photosensitive layer of the plate during storage and handling. Nonionic surfactants are particularly suitable. Preferred nonionic surfactants are polymers and oligomers containing one or more polyether (such as polyethylene glycol, polypropylene glycol, and copolymer of ethylene glycol and propylene glycol) segments. Examples of preferred nonionic surfactants are block copolymers of propylene glycol and ethylene glycol (also called block copolymer of propylene oxide and ethylene oxide); ethoxylated or propoxylated acrylate oligomers; and polyethoxylated alkylphenols and polyethoxylated fatty alcohols. The nonionic surfactant is preferably added at from 0.1 to 30% by weight of the photosensitive layer, more preferably from 0.5 to 20%, and most preferably from 1 to 15%.

In a preferred embodiment for violet or ultraviolet light sensitive lithographic printing plates of this invention, the photosensitive layer comprises a polymeric binder, a polymerizable ethylenically unsaturated monomer having at least one terminal ethylenic group, a free-radical initiator, and a violet or ultraviolet sensitizing dye. A hydrogen donor is preferably added to increase the photospeed. A nonionic surfactant is preferably added to enhance on-press developability. Other additives such as surfactant, dye or pigment, exposure-indicating dye, and free-radical stabilizer may be added. The monomer-to-polymer weight ratio is preferably at least 1.0, more preferably at least 1.5, and most preferably at least 2.0.

In another preferred embodiment for the violet or ultraviolet laser sensitive lithographic plates of this invention, the photosensitive layer comprises a polymeric binder, a monomer having at least 3 (meth)acrylate group, a hexaarylbiimidazole or titanocene compound, a dialkylaminobenzophenone compound, and a hydrogen donor compound. The monomer-to-polymer weight ratio is preferably at least 1.0, more preferably from 1.5 to 6.0, and most preferably from 2.0 to 5.0. A hexaarylbiimidazole compound is preferred among hexaarylbiimidazole and titanocene compounds. A preferred dialkylaminobenzophenone compound is a 4,4′-bis(dialkylamino)benzophenone compound.

In yet another preferred embodiment for the violet or ultraviolet laser sensitive lithographic plates of this invention, the photosensitive layer comprises a polymeric binder, a urethane monomer having at least 4 (meth)acrylate group, a hexaarylbiimidazole or titanocene compound, a dialkylaminobenzophenone compound, and a hydrogen donor compound. The monomer-to-polymer weight ratio is preferably at least 0.5, more preferably from 1.0 to 6.0, and most preferably from 2.0 to 5.0. A hexaarylbiimidazole compound is preferred among hexaarylbiimidazole and titanocene compounds. A preferred dialkylaminobenzophenone compound is a 4,4′-bis(dialkylamino)benzophenone compound. A non-urethane (meth)acrylate monomer can be added.

In further another preferred embodiment for the violet or ultraviolet laser sensitive lithographic plates of this invention, the photosensitive layer comprises a polymeric binder, a urethane monomer having at least 4 (meth)acrylate group, a non-urethane monomer having at least 4 (meth)acrylate groups, a hexaarylbiimidazole or titanocene compound, a dialkylaminobenzophenone compound, and a hydrogen donor compound. The weight ratio of the urethane (meth)acrylate monomer to the non-urethane (meth)acrylate monomer is preferably from 0.10 to 10.0, more preferably from 0.20 to 5.0, and most preferably from 0.30 to 3.0. The weight ratio for said monomers to the polymeric binders is preferably at least 0.5, more preferably from 1.0 to 6.0, even more preferably from 1.5 to 5.0, and most preferably from 2.0 to 4.0. A hexaarylbiimidazole compound is preferred among hexaarylbiimidazole and titanocene compounds. A preferred dialkylaminobenzophenone compound is a 4,4′-bis(dialkylamino)benzophenone compound.

On-press developable violet or ultraviolet laser sensitive lithographic plates and photosensitive layers as described in U.S. patent application Ser. Nos. 11/075,663, 11/175,518, 11/266,817, 11/336,132, and 11,356,911, the entire disclosures of which are hereby incorporated by reference, can be used for the instant invention.

A hydrophilic or oleophilic micro particles can be added into the photosensitive layer to enhance, for example, the developability and non-tackiness of the plate. Suitable micro particles include polymer particles, talc, titanium dioxide, barium sulfate, silicone oxide and aluminum micro particles, with an average particle size of preferably less than 5 microns, more preferably less than 2 microns and most preferably less than 1 microns. A suitable particular dispersion is described in U.S. Pat. No. 6,071,675, the entire disclosure of which is hereby incorporated by reference.

The photosensitive layer should exhibit an affinity or aversion substantially opposite to the affinity or aversion of the substrate to at least one printing liquid selected from the group consisting of ink and an abhesive fluid for ink. For example, a wet plate can have a hydrophilic substrate and an oleophilic photosensitive layer, or can have an oleophilic substrate and a hydrophilic photosensitive layer; a waterless plate can have an oleophilic substrate and an oleophobic photosensitive layer, or can have an oleophobic substrate and an oleophilic photosensitive layer. An abhesive fluid for ink is a fluid that repels ink. Fountain solution is the most commonly used abhesive fluid for ink. A wet plate is printed on a wet press equipped with both ink and fountain solution, while a waterless plate is printed on a waterless press equipped with ink.

For plates with rough and/or porous surface capable of mechanical interlocking with a coating deposited thereon, a thin water-soluble interlayer can be deposited between the substrate and the photosensitive layer. Here the substrate surface is rough and/or porous enough and the interlayer is thin enough to allow bonding between the photosensitive layer and the substrate through mechanical interlocking. Such a plate configuration is described in U.S. Pat. No. 6,014,929, the entire disclosure of which is hereby incorporated by reference. Preferred releasable interlayer comprises a water-soluble polymer. Polyvinyl alcohol (including various water-soluble derivatives of polyvinyl alcohol) is the preferred water-soluble polymer. Usually pure water-soluble polymer is coated. However, one or more surfactant and other additives can be added. The releasable interlayer preferably has an average coverage of 1 to 200 mg/m², more preferably 2 to 100 mg/m², and most preferably 4 to 40 mg/m². The substrate preferably has an average surface roughness Ra of 0.2 to 2.0 microns, and more preferably 0.4 to 1.0 microns.

The photosensitive layer may be conformally coated onto a roughened substrate (for example, with Ra of larger than 0.4 microns) at thin coverage (for example, of less than 1.2 g/m²) so that the plate can have microscopic peaks and valleys on the photosensitive layer coated surface and exhibit low tackiness and good block resistance, as described in U.S. Pat. No. 6,242,156, the entire disclosure of which is hereby incorporated by reference.

A water soluble or dispersible overcoat can be coated on the photosensitive layer to, for example, improve the photospeed, scratch resistance, and/or on-press developability of the plate. The overcoat preferably comprises a water-soluble polymer, such as polyvinyl alcohol (including various water-soluble derivatives of polyvinyl alcohol). Combination of two or more water-soluble polymers (such as a combination of polyvinyl alcohol and polyvinylpyrrolidone) can also be used. Polyvinyl alcohol is a preferred water-soluble polymer. Various additives, such as surfactant, wetting agent, defoamer, leveling agent and dispersing agent, can be added into the overcoat formulation to facilitate, for example, the coating or development process. Examples of surfactants useful in the overcoat of this invention include polyethylene glycol, polypropylene glycol, and copolymer of ethylene glycol and propylene glycol, polysiloxane surfactants, perfluorocarbon surfactants, alkylphenyl ethylene oxide condensate, sodium dioctylsulfosuccinate, sodium dodecylbenzenesulfonate, and ammonium laurylsulfate. Various organic or inorganic micro particles (such as talc and polymer particles) can be added into the overcoat to, for example, reduce the tackiness or moisture sensitivity of the plate. The overcoat preferably has a coverage of from 0.001 to 4.0 g/m², more preferably from 0.01 to 2.0 g/m², and most preferably from 0.1 to 1.0 g/m².

Violet or ultraviolet lasers useful for the imagewise exposure of the plates of this invention include any lasers having a wavelength of from 250 to 430 nm, such as violet laser diodes having a wavelength of from 390 to 430 nm, and ultraviolet laser diodes or LEDs having a wavelength of from 250 to 390 nm. Laser diodes are preferred violet or ultraviolet lasers. The exposure dosage is preferably from 1 to 2000 μJ/cm² (0.001 to 2 mJ/cm²), more preferably from 4 to 500 μJ/cm² (0.004 to 0.5 mJ/cm²), and most preferably from 10 to 200 μJ/cm² (0.01 to 0.20 mJ/cm²), depending on the sensitivity of the photosensitive layer.

The plate mounted on a lithographic press is exposed with a violet or ultraviolet laser, developed with ink and/or fountain solution, and then prints out regular printed sheets; the plate mounted on the plate cylinder is covered by the press covers to block off at least 95% (preferably at least 99%, more preferably at least 99.8%, and most preferably all) of the room light or of the unsafe portion of the room light during the exposure and on-press development. The ink and/or fountain solution solubilized or dispersed photosensitive layer (and overcoat, if any) can be mixed into the ink and/or the fountain solution on the rollers, and/or can be transferred to the blanket and then the receiving medium (such as paper). The fountain solution roller is engaged (to the plate cylinder as for conventional inking system or to the ink roller as for integrated inking system) for preferably 0 to 100 rotations, more preferably 1 to 50 rotations and most preferably 5 to 20 rotations (of the plate cylinder), and the ink roller is then engaged to the plate cylinder for preferably 0 to 100 rotations, more preferably 1 to 50 rotations and most preferably 5 to 20 rotations before engaging the plate cylinder and feeding the receiving medium. Good quality prints should be obtained preferably under 40 initial impressions, more preferably under 20 impressions, and most preferably under 5 impressions.

For conventional wet press, usually fountain solution is applied (to contact the plate) first, followed by contacting with ink roller. For press with integrated inking/dampening system, the ink and fountain solution are emulsified by various press rollers before being transferred to the plate as emulsion of ink and fountain solution. However, in this invention, the ink and fountain solution may be applied at any combination or sequence, as needed for the plate. There is no particular limitation. The recently introduced single fluid ink that can be used for printing wet lithographic plate without the use of fountain solution, as described in for example U.S. Pat. No. 6,140,392, can also be used for the on-press development and printing of the plate of this invention.

The ink used in this application can be any ink suitable for lithographic printing. Most commonly used lithographic inks include “oil based ink” which crosslinks upon exposure to the oxygen in the air and “rubber based ink” which does not crosslink upon exposure to the air. Specialty inks include, for example, radiation-curable ink and thermally curable ink. An ink is an oleophilic, liquid or viscous material which generally comprises a pigment dispersed in a vehicle, such as vegetable oils, animal oils, mineral oils, and synthetic resins. Various additives, such as plasticizer, surfactant, drier, drying retarder, crosslinker, and solvent may be added to achieve certain desired performance. The compositions of typical lithographic inks are described in “The Manual of Lithography” by Vicary, Charles Scribner's Sons, New York, and Chapter 8 of “The Radiation Curing: Science and Technology” by Pappas, Plenum Press, New York, 1992.

The fountain solution used in this application can be any fountain solution used in lithographic printing. Fountain solution is used in the wet lithographic printing press to dampen the hydrophilic areas (non-image areas), repelling ink (which is hydrophobic) from these areas. Fountain solution contains mainly water, generally with addition of certain additives such as gum arabic and surfactant. Small amount of alcohol such as isopropanol can also be added in the fountain solution. Water is the simplest type of fountain solution. Fountain solution is usually neutral to mildly acidic. However, for certain plates, mildly basic fountain solution is used. The type of fountain solution used depends on the type of plate substrate as well as the photosensitive layer. Various fountain solution compositions are described in U.S. Pat. Nos. 4,030,417 and 4,764,213.

This invention is further illustrated by the following non-limiting examples of its practice.

### EXAMPLES 1-5

This example demonstrates the importance of imaging and on-press developing a high-speed laser sensitive plate in the dark or under safe light.

An electrochemically roughened, anodized, and polyvinylphosphonic acid treated aluminum sheet was first coated with a 0.1% aqueous solution of polyvinyl alcohol (Celvol 540, from Celanese) with a #6 Meyer rod, followed by drying in an oven at 100 ° C. for 2 min. The polyvinyl alcohol coated substrate was further coated with the photosensitive layer formulation PS-1 with a #8 Meyer rod, followed by drying in an oven at 90° C for 2 min.

PS-1

| | Weight |
|---|---|
| Component | ratios |
| Neocryl B-728 (Polymer from Zeneca) | 3.193 |
| Sartomer SR-399 (Acrylic monomer from Sartomer) | 7.630 |
| Pluronic L43 (Nonionic surfactant from BASF) | 0.649 |
| 2,2-Bis(2-chlorophenyl)-4,4′,5,5′-tetraphenyl-1,1′-biimidazole | 1.407 |
| 2-Mercaptobenzoxazole | 0.839 |
| 4,4′-Bis(diethylamino)benzophenone | 0.281 |
| 2-Butanone | 86.000 |

The photosensitive layer coated plate was further coated with a water-soluble overcoat OC-1 using a #6 Meyer rod, followed by drying in an oven at 100° C. for 2 min.

OC-1

| Component | Weight ratios |
|---|---|
| Airvol 205 (polyvinyl alcohol from Air Products) | 0.40 |
| Dioctyl sulfosuccinate sodium salt (surfactant) | 0.02 |
| Water | 99.58 |

The plate was exposed with a violet plate imager equipped with a 30 mw violet laser diode emitting at about 405 nm (MAKO-4 from ECRM) for a dosage of about 60 μJ/cm². The plate was imaged in a dim red light room, and was kept in a light tight box before and after imaging.

The laser exposed plate was cut into five pieces, and each piece was wrapped with a separate aluminum foil. Each piece of the plate was tested on press under a different lighting condition. The first piece was tested in the dark (with all lights turned off). The second piece was tested under a 60-watt yellow light (yellow coated incandescence light, from General Electric). The third piece was tested under a 60-watt red light (red coated incandescence light, from General Electric). The fourth piece was tested under a 20-watt white office fluorescence light (from General Electric). The fifth piece was tested under a 100-watt regular incandescence light (for home use, from General Electric). Each light was about 2 meters from the top of the press. It took about 5 minutes to mount each plate and start up the press.

Each of the exposed plate pieces was unwrapped and tested on a wet lithographic press (AB Dick 360) under the above described lighting condition (including dark). The plate was directly mounted on the plate cylinder of the press. After starting the press, the fountain roller was engaged for 20 rotations, the ink roller (carrying emulsion of ink and fountain solution) was applied to the plate cylinder for 20 rotations, and the plate cylinder was then engaged with the blanket cylinder and printed with paper. The printed sheets were evaluated for the on-press developability of the plates, with the results summarized in Table 1.

TABLE 1

| | Background | Background | |
|---|---|---|---|
| | at 20 | at 200 | Inking in |
| Press room lighting | impressions | impressions | imaging areas |
| In the dark (no light) | Clean | Clean | Good |
| Yellow light | Clean | Clean | Good |
| Red light | Clean | Clean | Good |
| White fluorescence light | Inked | Heavy toning | Good |
| Regular incandescence | Inked | Heavy toning | Good |
| light | | | |

I claim:

1. A lithographic printing press comprising:
(a) a plate cylinder;
(b) an exposure means capable of emitting a laser with a wavelength selected from 250 to 430 nm to imagewise expose a lithographic printing plate mounted on said cylinder; and
(c) an inking means comprising an inking unit or both an inking unit and a fountain unit;
(d) wherein at least said plate cylinder as well as the plate mounted on it is within a compartment shielded with covers and other press parts so that no or less than 5% of the room light with a wavelength of shorter than 450 nm reaches the plate mounted on the plate cylinder.

2. The lithographic press of claim 1 wherein said exposure means and said inking means are within said compartment.

3. The lithographic press of claim 1 wherein the entire press except for certain controlling handles or buttons are within the compartment shielded with covers.

4. The lithographic press of claim 1 wherein less than 1% of the room light with wavelength shorter than 450 nm reaches said plate.

5. The lithographic press of claim 1 wherein less than 0.2% of the room light with wavelength shorter than 450 nm reaches said plate.

6. The lithographic press of claim 1 wherein no room light with wavelength shorter than 450 nm reaches said plate.

7. The lithographic press of claim 1 wherein less than 1% of the room light with wavelength shorter than 500 nm reaches said plate.

8. The lithographic press of claim 1 wherein less than 1% of the room light with wavelength shorter than 550 nm reaches said plate.

9. The lithographic press of claim 1 wherein less than 1% of the room light at any wavelength reaches said plate.

10. The lithographic press of claim 1 wherein no room light reaches said plate.

11. The lithographic press of claim 1 wherein said plate cylinder is further mounted with a lithographic printing plate comprising on a substrate a photosensitive layer soluble or dispersible in ink and/or fountain solution and capable of hardening upon exposure to said laser at a dosage of less than 500 μJ/cm².

12. The lithographic press of claim 1 wherein said compartment comprises at least one removable window to allow opening a portion of the covers to view inside the compartment under room light after on-press development.

13. The lithographic press of claim 1 wherein said covers include certain areas which are non-transparent to any white light and other areas which are only transparent to a yellow or red light.

14. The lithographic press of claim 1 wherein said covers have certain areas which are only transparent to a yellow or red light, and said compartment further contains a yellow or red light source to facilitate viewing of the plate mounted on the cylinder.

15. The lithographic press of claim 1 further comprising a light-tight cassette containing at least one lithographic plate for automatically loading the lithographic plate onto the plate cylinder; said cassette being either all inside the compartment, all outside the compartment having a light-tight slot, or partially inside the compartment.

16. The lithographic press of claim 1 wherein the lithographic plate is in the form of continuous web with one end rolled out from a fresh roll of plate in a light-light cartridge and the other end rolled into a used roll in a second cartridge, both cartridges are installed within the plate cylinder with the portion of the plate between the cartridges being mounted on the plate cylinder, and said plate is capable of unwinding from the light-tight cartridge and winding into the second cartridge at the beginning of a printing operation.

17. A lithographic printing press comprising:
(a) a plate cylinder mounted with a lithographic printing plate having on a substrate a photosensitive layer soluble or dispersible in ink and/or fountain solution and capable of hardening upon exposure to a laser having a wavelength selected from 250 to 430 nm at a dosage of less than 500 μJ/cm2;
(b) an exposure means capable of emitting said laser to imagewise expose said mounted plate; and
(c) an inking means comprising an inking unit or both an inking unit and a fountain unit;
(d) wherein at least said plate cylinder as well as the plate mounted on it is within a compartment shielded with covers and other press parts so that no or less than 1% of the room light with a wavelength of shorter than 450 nm reaches the plate mounted on the plate cylinder.

18. A method of lithographically printing images on a receiving medium, comprising in order:
(a) providing a lithographic printing press comprising (i) a plate cylinder (ii) an exposure means capable of emitting a laser having a wavelength selected from 250 to 430 nm, and (iii) an inking means comprising an inking unit or both an inking unit and a fountain unit;
(b) mounting onto said plate cylinder a lithographic printing plate comprising on a substrate a photosensitive layer soluble or dispersible in ink and/or fountain solution and capable or hardening upon exposure to said laser,
(c) imagewise exposing said plate with said laser at a dosage of less than 500 μJ/cm² to cause hardening of the photosensitive layer in the exposed areas;
(d) applying ink and/or fountain solution from said inking means to said plate to remove the non-hardened areas of said photosensitive layer; and
(e) lithographically printing images from said plate to the receiving medium;
(f) wherein at least said plate mounted on the plate cylinder is within a compartment shielded with covers and other press parts so that no or less than 5% of the room light with a wavelength of shorter than 450 nm reaches the plate.

19. The method of claim 18 wherein the entire press except for certain controlling handles or buttons are within the compartment shielded with covers.

20. The method of claim 18 wherein less than 1% of the room light with wavelength shorter than 450 nm reaches said plate.

21. The method of claim 18 wherein less than 0.2% of the room light with wavelength shorter than 450 nm reaches said plate.

22. The method of claim 18 wherein no room light with wavelength shorter than 450 nm reaches said plate.

23. The method of claim 18 wherein less than 1% of the room light at any wavelength reaches said plate.

24. The method of claim 18 wherein said covers include certain areas which are non-transparent to any white light and other areas which are only transparent to a yellow or red light.

25. The method of claim 18 wherein said compartment comprises one or more removable windows as part of the covers, said windows are all closed in steps (b) to (d) to prevent the room light or the unsafe portion of the room light from entering the compartment, and at least one of said windows is open in all or part of the duration of step (e) to allow viewing inside the compartment or allow ventilation.

26. The method of claim 18 wherein said lithographic plate further comprises a water soluble or dispersible overcoat on said photosensitive layer.

27. The method of claim 18 wherein said lithographic plate is automatically mounted onto the plate cylinder from a light-tight cassette containing at least one lithographic plate; said cassette being either all inside the compartment, all outside the compartment having a light-tight slot, or partially inside the compartment.

28. The method of claim 18 wherein the lithographic plate is in the form of continuous web with one end rolled out from a fresh roll of plate in a light-light cartridge and the other end rolled into a used roll in a second cartridge, both cartridges are installed within the plate cylinder with the portion of the plate between the cartridges being mounted on the plate cylinder, and said plate is unwound from the light-tight cartridge and wound into the second cartridge in order to mount a fresh portion to replace a used portion of the plate on the plate cylinder at the beginning of a new printing operation (step b).
